(19) United States
(12) Patent Application Publication
(10) Pub. No.: US 2026/0134314 A1
(43) Pub. Date: May 14, 2026

(54) BLOCKCHAIN-BASED ARTIFICIAL INTELLIGENCE SYSTEM

(71) Applicant: Ruben Buckris, Brooklyn, NY (US)

(72) Inventor: Ruben Buckris, Brooklyn, NY (US)

(21) Appl. No.: 19/436,068

(22) Filed: Dec. 30, 2025

Related U.S. Application Data
(63) Continuation-in-part of application No. 18/425,896, filed on Jan. 29, 2024, now Pat. No. 12,526,139.

(51) Int. Cl. G06N 5/045; H04L 9/00; H04L 9/32

(52) U.S. Cl. CPC G06N 5/045; H04L 9/3236; H04L 9/50; H04L 2209/463

(57) ABSTRACT

A blockchain-based artificial intelligence system, with the training of neural network nodes being obtained via oracle-assisted local devices. Nodes are trained using local data, which are then transmitted to the blockchain node application via a smart contract-based electronic transfer platform. Security of the system is ensured using an actively updated anomaly database to detect anomalous code segment updates and anomalous blockchain activity. AI global models are versioned to enable reversion if an operating model is determined to be anomalous.

### PRIORITY

This application is a continuation-in-part of and claims the benefit and priority to U.S. non-provisional application Ser. No. 18/425,896, filed Jan. 29, 2024. The referenced application is incorporated herein as if restated in full.

### SUMMARY

By integrating blockchain and neural networks, it is possible to combine the decentralization, transparency, and security of blockchain with the learning capabilities of neural networks. A description of the integration of these two technologies is below.

In one embodiment, the blockchain is used to create a decentralized network for federated learning. Federated learning is a decentralized machine learning approach that allows a model to be collaboratively trained across multiple decentralized edge devices (such as smartphones, IoT devices, or other local nodes) holding local data samples, and the learnings are aggregated to improve the overall model without exposing individual data points. Participants, i.e., nodes, in the network each have access to local data which is contributed to the learning.

Federated learning may involve the initialization of a global model on a central server. This global model may be distributed to a plurality of local devices (i.e., nodes) which in turn participate in the federated learning process by training the localized model using the local device data. In order to maintain privacy, the local device data (raw data) is not sent to the central server; instead, after local training, only the updates to the local models (i.e., gradients or weights) are transmitted to the central server—these updates are used to update the global model. The steps of model distribution, local training, model updates, and global incorporation of those updates may be repeated iteratively. The updates are then stored on the blockchain, where consensus mechanisms may be utilized to ensure integrity of the learning process and the model generally.

In one embodiment, for training with real-world data, oracles can be used to feed such data into smart contracts and neural networks. This enables the training of the AI system with up-to-date information. The oracles may provide the initial global model parameters, assist in aggregation of model updates, optimize hyperparameters of the federated learning algorithm, etc. Oracles may be smart contracts themselves, guidance mechanisms providing external data to the smart contracts to assist in decision making, artificial intelligent systems, or other entities or systems.

The exchange of data may be facilitated by a decentralized data marketplace, which may be a platform or system utilizing a blockchain infrastructure. Distributed ledger technology may be used to ensure data exchanges that are both transparent and secure. Further, the exchange may be executed using smart contracts to enforce transaction terms and automate transactions. The data exchanged via the decentralized data marketplace may be used in the federated learning described above. Token-based systems may be implemented to incentivize data sharing.

The learning process may be facilitated by smart contracts deployed on the blockchain. The smart contracts may distribute the initial global model parameters to the local devices, arrange for the encrypted transfer of the trained global model nodes, and enable the updating and validating of the global models. In order to incentivize the training of the global model nodes, the smart contracts may reward local devices for their processing and data contributions with cryptographic tokens.

Homomorphic encryption is a cryptographic technique that enables computations to be performed on encrypted data without decrypting it first. In one embodiment, homomorphic encryption can be combined with federated learning to allow training on encrypted local data. This ensures that sensitive data remains confidential even when computations are performed across the decentralized networks. Homomorphic encryption may include partially homomorphic encryption, where a single operation (such as addition or multiplication) is performed on the encrypted data, or fully homomorphic encryption, in which two operations (such as addition and multiplication) are performed.

Homomorphic encryption involves a public key and a secret key, with the public key being used for encrypting the data and the secret key is used to decrypt the data. The local devices may use local public keys or grandmaster public keys distributed by the smart contracts or explicit in the global model itself. The secret keys may be generated locally and then sent securely via smart contract functions to the central server, or they may be generated implicitly, securely, and in an encrypted manner within the global model.

In one embodiment, once a neural network is trained, its model parameters, or even the entire model, may be stored on the blockchain, thereby bestowing on it a degree of immutability and transparency. In one variation, users can verify the integrity of the model by checking the data stored on the blockchain.

In one embodiment, the neural networks are stored on decentralized storage systems such as the InterPlanetary File System (IPFS). Thus, neural network nodes are distributed in a decentralized manner across a plurality of network nodes (e.g., local devices). Hashes or references to the data can be stored on the blockchain, ensuring efficient storage and retrieval of blockchain and AI-related data. Versioning and duplication mechanisms can be used to ensure that previous versions of the blockchain and AI-related data remain available while preserving the cohesion of the global/local models.

The blockchain may be used to train, store, and operate an AI system, but AI can also be used to preserve the blockchain, and therefore the trained, stored, and operated AI system.

The components of an effective and efficient AI System, such as training data, model parameters, and updates, may be stored on the blockchain, and thus the blockchain may operate as a platform for training the AI system. A blockchain based AI system may accordingly be decentralized, immutable, transparent, and tamper resistance. Additionally, the blockchain may be used to execute the operation of the AI System via smart contracts and other decentralized applications.

The AI system trained, stored, and operated by the blockchain can be the same AI system, a portion of the same AI system, or a separate AI system than the AI system that is designed at least in part to preserve and facilitate the operation of the blockchain, with the former being a so-called “decentralized AI system” and the latter being a so-called “blockchain governing AI system”. Thus, there may be a bilateral symbiotic relationship between the blockchain and the AI system(s). The blockchain benefits from AI by gaining advanced analytical capabilities, improved security measures, and optimized consensus mechanisms. The AI system(s) benefit from the blockchain by having a decentralized and transparent platform for training, storage, and operation, as well as by leveraging the blockchain's security features.

The blockchain governing AI system may contribute to the preservation of the blockchain by analyzing and securing data. It may employ anomaly detection, encryption, or other security measures to ensure the integrity of the data stored on the blockchain. AI algorithms may be applied to optimize and enhance the consensus mechanisms used by the blockchain by using machine learning to improve the efficiency and security of consensus protocols. AI-based monitoring systems can actively watch for unusual patterns, potential attacks, or performance issues within the blockchain network. Early detection of anomalies can contribute to the overall health and security of the blockchain.

The decentralized AI system trained, stored, and operated by the blockchain can be the same system as the blockchain governing AI system. In this case, the blockchain not only serves as a training ground but also provides a secure and transparent environment for the continuous operation of the AI.

Different components of the AI system might be distributed. For instance, some components may reside on the blockchain for execution, while others operate off-chain. This hybrid approach allows for flexibility and scalability with an overlap between the blockchain governing AI system and the decentralized AI system, such that the blockchain governing AI system is party decentralized.

Another AI system may be specifically designed to preserve and enhance the blockchain. This AI could focus on security, optimization, or efficiency measures to maintain the robustness of the blockchain infrastructure.

In one embodiment, Decentralized Autonomous Organizations (DAOs) can be formed to govern AI initiatives. Token holders in the DAO can collectively make decisions about model updates by evaluating the impact of model impacts on performance, accuracy, and other relevant metrics; voting mechanisms such as whether a given decision—or all decisions—should be made by a simple majority vote or some more sophisticated voting system; data usage policies, including permissions for data access to ensure privacy compliance, or whether to integrate new data sources into the AI system based on the diversity and representativeness of the training data; the incentive reward structures for encouraging data contributors, developers, and other participants to contribute to the AI system's improvement; staking mechanisms enabling token holders to stake tokens to signal confidence in regard to specific model updates; governing policies including DAO governance rules and smart contract updates; as well as overall AI strategy.

In one embodiment, the AI system is run independently on nodes throughout a network. The AI system may comprise a governance system that manages ledger-holder voting mechanisms, encryption and decryption actions, codebase amendment allowances, disclosure gatekeeping, and other tasks relating to the maintenance, security, efficiency, and efficacy of the blockchain.

Detecting changes to a blockchain codebase is crucial for maintaining the integrity and security of the system. In one embodiment, the AI System may detect unauthorized changes to the blockchain code. Below are methods to design a blockchain-based AI system that can effectively detect and analyze changes to its codebase:

In one embodiment, the AI system implements a version control system for the blockchain database. Changes are tracked, and updates or modifications are documented. The AI System may implement tamper-evident logging mechanisms to automatically record all changes to the codebase as well as any other relevant details pertaining to the changes. The change logs may be analyzed for vulnerabilities or potential exploitation. In one version, the AI system uses static analysis and dynamic analysis tools to identify potential vulnerabilities in changes to the code. Using static code analysis, the AI system may detect insecure dependencies and potential attack vectors. AI Algorithms may learn from historical data and known vulnerabilities to identify patterns indicative of malicious code. Known vulnerabilities may be searched on dedicated databases, forums, etc. Using dynamic code analysis, the AI system may examine the behavior of the blockchain code during runtime. This involves executing the code in a controlled environment and monitoring it for unexpected actions.

In one embodiment, the AI system executes periodic automated testing and verification of the codebase integrity and authenticity using both static and dynamic analysis techniques. The AI system may monitor the testing for irregularities or unexpected changes. In one embodiment, random transactions are audited for anomalous behavior. One technique the AI system may use to determine such anomalous behavior is by determining if the audited transaction would be executed differently if it occurred on a prior version of the codebase, and then determining if any of the parties connected to the transaction, or parties connected to those parties, were involved in the changes, either through recommendation of changes or voting for said changes.

The AI System may analyze the code for vulnerabilities and calculate a risk level for any vulnerabilities detected. The calculated risk level may be incorporated into recommendations for reducing the risk level, which in turn may be incorporated into communications transmitted to ledger-holders. The recommendations may include selections of code to be swapped with functionally equivalent safe code, or code which is known to support the rest of the system without introducing dangerous functionalities.

The AI System, upon detecting a vulnerability, either in the codebase or in proposed or pending changes, may determine how to fix the vulnerability by replacing the code using databases of known solutions or using historical data. If a known solution exists in the vulnerability database, the AI system may automatically generate a patch or suggest a fix. This could involve replacing or updating the affected code with a more secure version. Depending on the nature of the vulnerability, the AI system may recommend replacing the vulnerable code with a safer alternative or modifying the code to eliminate the security flaw. The replacement code could be sourced from a library of secure code snippets. The AI system analyzes historical data to understand how similar vulnerabilities were addressed in the past. This helps in making informed decisions about the most effective and secure fixes.

In one embodiment, the AI System generates a cryptographic hash of the codebase and stores it on the blockchain. The AI System may generate iterative cryptographic hashes of the codebase whenever an approved change to the codebase is effected. These iterative cryptographic hashes may comprise only the changes and data pertaining to those changes, or alternatively the entirety of the changed code. In one variation, the ledger holders who approved and/or disapproved of the change is additionally hashed into the codebase. In yet another variation, each party responsible for effecting the change is hashed into the codebase.

In one embodiment, the AI System stores the decryption key for the cryptographic hashes of the codebase, changes to the codebase, and the ledgerholders/parties associated with changes or votes to change the codebase. The AI System may store the decryption key within or separately from the blockchain. The AI System may store the codebase as well as any changes in decentralized repositories having a riding relationship with the main blockchain, such that it shares ledger-holders in common but constitutes a separate blockchain.

The AI system continuously monitors the codebase and determines if changes are being made, or it may periodically verify the cryptographic hash against the current state of the codebase. Mismatches indicate tampering with the code.

In one embodiment, the AI System may alert ledger holders of attempts to change or otherwise tamper with the codebase. This alert may take the form of notifications through a secure communication channel or a dedicated dashboard.

In one embodiment, the AI system comprises a communication module, which may be a set of algorithms, databases, and user interfaces, for communicating with ledgerholders or other interested parties. The AI system may inquire, using natural language processing, as to whether the users gave their consent to, approval for, or rejected the changes. The AI system may receive responses from the ledgerholders via the same communication module.

In one embodiment, upon detecting changes or requests for changes to the blockchain, the AI system will halt all transactions or recordations from or pertaining to a ledgerholder until the ledgerholder approves or rejects such changes.

In one variation, ledger holders are given a cryptocurrency reward for responding to AI system communications regarding proposed or detected changes. In another variation, ledger holders are conversely penalized for not responding.

In one variation, the blockchain's core functionality is immutable once deployed.

In another variation, codebase changes require multi-signature authorization from ledger holders.

In another variation, code changes require an encrypted voting mechanism embedded in the blockchain that enables ledger holders to vote for any proposed amendments to the code base.

In one embodiment, the AI system comprises a mechanism for emergency code rollback upon detecting an unauthorized change. In one variation, the rollback is effected immediately upon detecting the unauthorized change. In another variation, the rollback is effected after receiving multi-signature or consensus approval from ledger holders. In yet another variation, the rollback is effected after a set period of time unless the rollback is disapproved by ledger holders within that set period.

The blockchain consensus mechanism may be proof of stake (PoS) or delegated proof of stake (DPoS).

### BRIEF DESCRIPTION

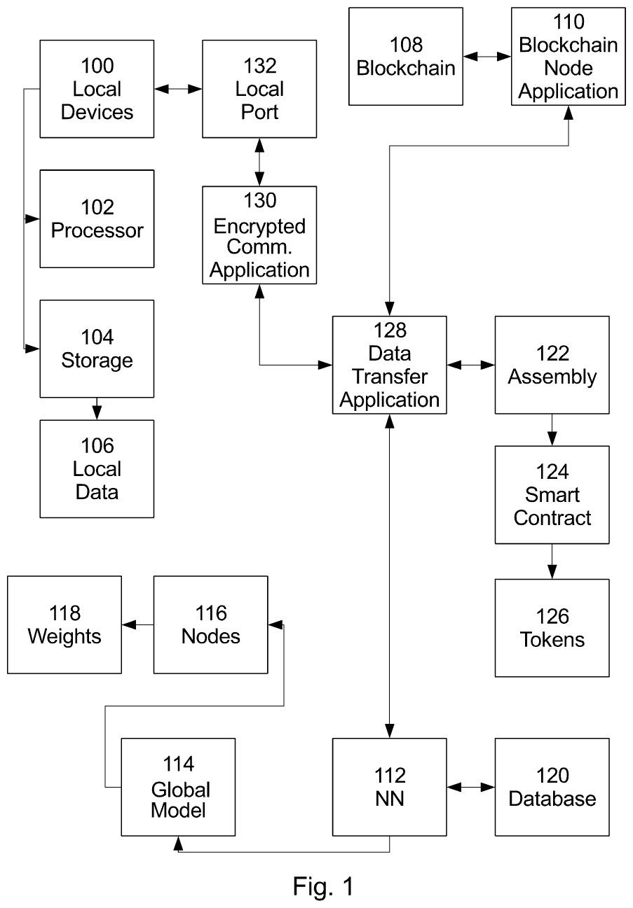

FIG. 1 shows an exemplary system architecture.

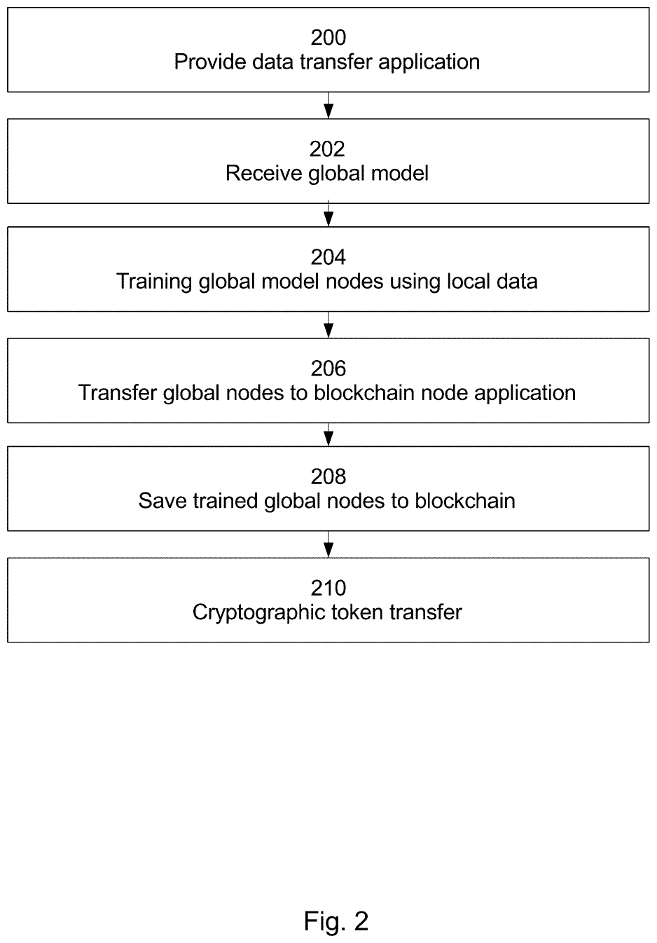

FIG. 2 shows an exemplary system process.

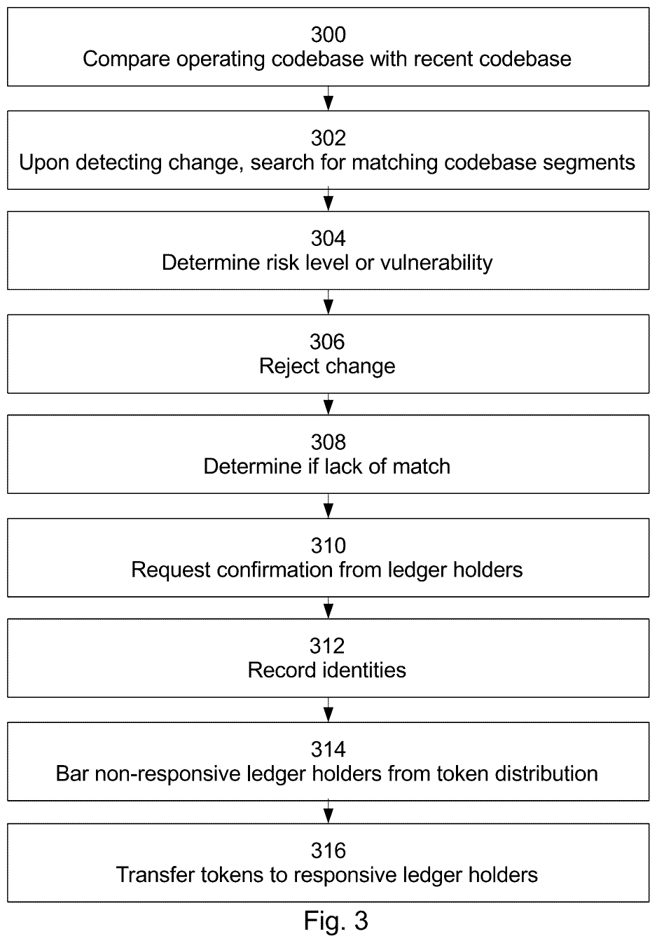

FIG. 3 shows an exemplary system process.

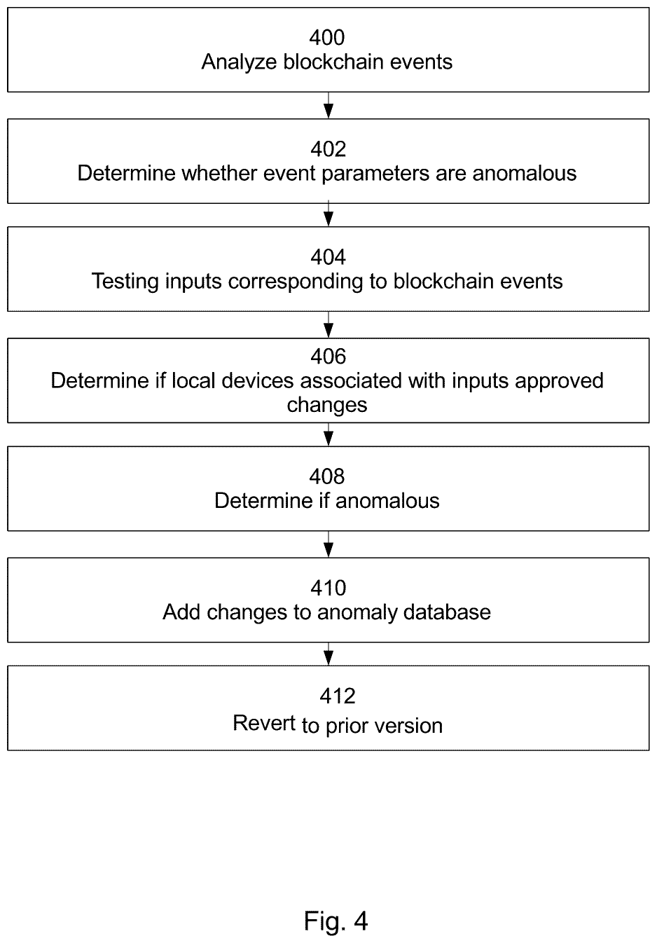

FIG. 4 shows an exemplary system process.

### DETAILED DESCRIPTION

Monitoring and governance of the Blockchain-based AI System may be achieved through the implementation of smart contracts, particularly a smart contract assembly configured to execute a plurality of mutually engaging smart contracts. Each smart contract may have a designate task or set of tasks, such as storing the blockchain codebase, proposing changes, or managing the confirmation or voting process pertaining to those changes.

The system may feature a platform or ecosystem comprising a plurality of local devices controlled by disparate users. Each of these users may, through their local devices, serve as ledger holders for the blockchain, and accordingly, may partake in the confirmation or voting process.

The system may comprise an AI monitoring module. The module may comprise a set of AI algorithms stored on and/or run off-chain and/or on-chain to monitor the blockchain's codebase for changes. This module may periodically compute the hash of the current codebase and compare it with the stored hash. If a change is detected, the AI monitoring module may trigger the proposal of a new code base hash through the Codebase Monitor Contract. The Codebase Monitor Contract receives the proposed codebase hash from the AI module and emits an event to notify the ledger holders about the proposed change. Ledger holders receive notifications of the proposed change and can participate in the confirmation/voting process.

A voting module, optionally coupled to the encrypted communication module and managed by the smart contract assembly (via a governance contract), may enable ledger holders to vote on proposed codebase changes. The smart contract assembly may set a confirmation threshold, such as a supermajority vote, for acceptance of codebase change proposals.

The AI System may comprise expert systems or neural networks. The neural networks may be trained using the blockchain itself, where ledger holders provide the processing power for training and running the neural networks. The trained neural network may be saved as blocks of data on the blockchain.

Artificial Intelligence as Ledger Holder (General Architecture)

In one embodiment, the artificial intelligence system is configured to operate as a ledger holder of a blockchain, such that authoritative ledger state is maintained, validated, and updated by one or more artificial intelligence agents executing on one or more computing systems. In this embodiment, the artificial intelligence system assumes responsibility for ledger integrity, transaction validation, consensus determination, and ledger state finalization, without requiring human-operated validator or miner nodes.

The artificial intelligence system may comprise a ledger-management module, a transaction-validation module, a consensus-coordination module, a cryptographic identity module, and a state-persistence module, each implemented as executable instructions stored on non-transitory computer-readable media and executed by one or more processors. Human-controlled devices may interact with the system as external clients, transaction originators, or query interfaces, but are not required to operate independent full nodes holding authoritative copies of the blockchain ledger.

### Artificial Intelligence Ledger-Holder Agents

In one embodiment, the blockchain system comprises a plurality of artificial intelligence ledger-holder agents, each ledger-holder agent being instantiated as an independent execution environment with access to persistent storage, cryptographic key material, and network communication interfaces. Each artificial intelligence ledger-holder agent is configured to maintain a copy of at least a portion of a blockchain ledger.

### Ledger Portion Determination (Logical Partitioning)

In one embodiment, the portion of the blockchain ledger maintained by a given artificial intelligence ledger-holder agent is determined according to a ledger partitioning scheme. The ledger partitioning scheme divides the blockchain ledger into logical ledger data portions defined independently of physical storage location. Ledger data portions may be defined based on transaction ranges, block ranges, account address ranges, smart-contract identifiers, state variable groupings, or shard identifiers.

Each artificial intelligence ledger-holder agent may be assigned responsibility for validating transactions affecting one or more ledger data portions. Assignment of validation responsibility does not require exclusive responsibility for physical storage of the corresponding ledger data.

In one variation, the ledger partitioning scheme is dynamically determined by a logical assignment or load-balancing module executed by the artificial intelligence system. Ledger portion responsibility may be assigned or reassigned based on computational capacity, network latency, historical reliability, fault tolerance metrics, or ledger growth patterns.

In another variation, each artificial intelligence ledger-holder agent maintains a complete copy of the blockchain ledger while logically operating on designated ledger data portions for purposes of validation, voting, or consensus participation.

### Transaction Intake

Each artificial intelligence ledger-holder agent comprises a transaction intake interface configured to receive proposed blockchain transactions. Proposed transactions may be received from external client devices, application programming interfaces, smart contracts, other artificial intelligence ledger-holder agents, or intermediary transaction propagation services.

In one embodiment, proposed transactions are routed to ledger-holder agents based on ledger data portion responsibility. In another embodiment, proposed transactions are broadcast to multiple artificial intelligence ledger-holder agents for parallel validation.

### State Transitions and Simulation

Upon receiving a proposed transaction, an artificial intelligence ledger-holder agent validates the transaction by simulating one or more state transitions of the blockchain ledger. A state transition refers to a deterministic change in ledger state that would result from applying the proposed transaction to a current ledger state.

Ledger state may include account balances, smart-contract variables, execution context, storage mappings, memory states, model parameters, or other stateful blockchain data.

In one embodiment, state transition simulation is performed using a virtual execution environment that emulates blockchain protocol rules without committing changes to the authoritative ledger. The artificial intelligence ledger-holder agent may compute resulting state changes, execution traces, resource consumption metrics, and constraint compliance indicators. Simulation results may be evaluated against protocol rules, anomaly thresholds, or learned behavioral models to determine transaction validity.

### Cryptographic Attestations

Upon determining transaction validity, an artificial intelligence ledger-holder agent generates a cryptographic attestation indicating transaction validity. The cryptographic attestation may comprise a digitally signed data structure including a cryptographic hash of the proposed transaction, a hash of the simulated resulting ledger state, a timestamp, and an identifier of the artificial intelligence ledger-holder agent.

In one variation, cryptographic attestations are generated using private cryptographic keys associated with the artificial intelligence ledger-holder agents and are verifiable using corresponding public keys. In other variations, cryptographic attestations may comprise threshold signatures, aggregated signatures, or zero-knowledge proofs indicating compliance with protocol constraints without revealing underlying transaction details.

### Consensus-Coordination Module

In one embodiment, the artificial intelligence ledger-holder architecture further comprises a consensus-coordination module configured to manage agreement among the artificial intelligence ledger-holder agents. The consensus-coordination module may be executed by each ledger-holder agent or implemented as a distributed protocol cooperatively executed across the ledger-holder agents.

The consensus-coordination module exchanges validation data among the artificial intelligence ledger-holder agents. Validation data may include transaction identifiers, simulated state transition results, execution traces, constraint-violation indicators, resource-consumption metrics, cryptographic hashes of simulated ledger states, and cryptographic attestations.

Validation data may be exchanged in structured rounds. In an initial round, ledger-holder agents disseminate validation results. In subsequent rounds, ledger-holder agents exchange confirmations, objections, or cryptographic attestations indicating agreement or disagreement.

The consensus-coordination module determines agreement by evaluating received validation data against one or more consensus thresholds. Consensus thresholds may require a defined number, percentage, or weighted combination of ledger-holder agents indicating validity. Thresholds may be fixed or dynamically determined based on trust scores, historical validation accuracy, staking parameters, or fault-tolerance criteria.

Upon determining agreement, the consensus-coordination module determines a ledger state update corresponding to the validated transaction or candidate block. In one embodiment, cryptographic attestations from multiple ledger-holder agents are aggregated to form a consensus certificate authorizing ledger update finalization. In another embodiment, a designated ledger-holder agent assembles and propagates the finalized ledger update.

If agreement is not reached, the consensus-coordination module may initiate additional validation rounds, exclude non-responsive or anomalous agents, or defer ledger updates. Consensus outcomes and fault events may be logged to update trust metrics or anomaly records associated with the ledger-holder agents.

### Artificial Intelligence Agents Communicating With Users

In one embodiment, one or more artificial intelligence ledger-holder agents are further configured to communicate with external users through a structured communication interface. The communication interface may provide explanatory information regarding transaction validation outcomes, consensus determinations, detected anomalies, or ledger state changes.

Communication between artificial intelligence ledger-holder agents and external users is informational and non-authoritative. User-facing communications do not permit external users to directly modify ledger state, validation logic, consensus thresholds, cryptographic authorization, or shard assignment.

In one embodiment, explanatory outputs improve transparency, auditability, and user trust in blockchain systems where artificial intelligence agents perform validation or consensus roles traditionally occupied by human operators.

In one embodiment, communication risks are mitigated by restricting the communication interface to predefined message schemas, enumerated reason codes, or structured summaries derived from recorded validation data. The communication interface is logically separated from validation and consensus pathways, such that explanatory communication cannot influence real-time ledger decisions.

Artificial intelligence ledger-holder agents may further enforce authentication, authorization, and rate-limiting controls on user communications. User-provided input may be logged or incorporated into offline analysis or future training processes, but cannot override or interfere with ledger state determination.

### Transaction Simulation Module Architecture

In one embodiment, each artificial intelligence ledger-holder agent comprises a transaction simulation module configured to evaluate proposed blockchain transactions prior to acceptance or consensus voting. The transaction simulation module operates as a logical or software-defined component executed by one or more processors of the ledger-holder agent and may be implemented as a virtual execution environment, a sandboxed interpreter, or a protocol-compliant simulation engine.

The transaction simulation module is configured to receive proposed blockchain transactions and access ledger state information required to simulate execution of the transactions. Ledger state information may include current account balances, smart-contract storage variables, execution context parameters, protocol configuration data, or other stateful ledger data relevant to transaction execution.

In one embodiment, the transaction simulation module maintains a local copy or snapshot of ledger state for simulation purposes. The snapshot may be derived from the authoritative ledger state, a locally maintained ledger copy, or a subset of ledger data portions assigned to the artificial intelligence ledger-holder agent.

### Simulation Processes and Deterministic Execution

In one embodiment, upon receipt of a proposed transaction, the transaction simulation module executes a deterministic simulation process. The simulation process applies protocol-defined execution rules to the proposed transaction using the ledger state snapshot, without committing any resulting state changes to the authoritative ledger.

The simulation process may include verification of cryptographic signatures, evaluation of transaction format and constraints, execution of smart-contract logic, and enforcement of protocol-specific rules. The transaction simulation module executes the transaction in a controlled environment that replicates the execution semantics of the blockchain protocol.

During simulation, the transaction simulation module generates predicted downstream ledger states corresponding to application of the transaction. Predicted downstream ledger states represent hypothetical ledger states that would result if the transaction were committed, including updated balances, modified storage variables, or altered governance parameters.

### Execution Trace and Resource-Consumption Analysis

In one embodiment, the transaction simulation module generates execution traces representing a sequence of execution steps performed during transaction simulation. Execution traces may include instruction-level operations, function calls, memory access events, or state variable updates. Execution traces may be used to verify correctness, detect anomalous behavior, or support auditability.

In one embodiment, the transaction simulation module computes resource-consumption metrics associated with transaction execution. Resource-consumption metrics may include computation costs, memory usage, storage access frequency, execution time estimates, or gas-like consumption parameters defined by the blockchain protocol.

The transaction simulation module may compare computed resource-consumption metrics against protocol-defined limits or thresholds to determine whether the proposed transaction satisfies acceptance criteria.

### Simulation Outcomes and Integration With Validation

In one embodiment, the transaction simulation module produces a simulation outcome comprising one or more of: predicted downstream ledger states, execution traces, resource-consumption metrics, and validity indicators. Simulation outcomes may be stored temporarily, logged, or encapsulated within validation messages generated by the artificial intelligence ledger-holder agent.

The artificial intelligence ledger-holder agent evaluates the simulation outcome to determine transaction validity. If the simulation outcome indicates compliance with protocol rules and constraints, the agent may generate a cryptographic attestation indicating transaction validity. If the simulation outcome indicates violations or anomalies, the agent may generate a rejection indicator or anomaly record.

Simulation outcomes may be shared with other artificial intelligence ledger-holder agents as part of the consensus-coordination process. In one embodiment, cryptographic hashes or summaries of simulation outcomes are exchanged to support efficient consensus determination without disclosing full execution details.

### Isolation and Non-Commitment Guarantees

In one embodiment, the transaction simulation module is configured such that simulation execution is isolated from authoritative ledger state. Simulation results do not modify ledger state, cryptographic keys, or consensus parameters unless and until authorized through a finalized consensus process.

The transaction simulation module may discard or archive simulation results following completion of validation and consensus. Isolation of simulation ensures that transaction evaluation is deterministic, repeatable, and free from side effects that could compromise ledger integrity.

### Optional Enhancements and Variations

In one embodiment, the transaction simulation module may employ parallel simulation techniques to evaluate multiple transactions concurrently. In another embodiment, the simulation module may pre-simulate transaction batches or candidate blocks to optimize throughput.

In further variations, the transaction simulation module may incorporate learned models to assist in anomaly detection or risk assessment during simulation, while preserving deterministic execution of protocol-defined state transitions.

### Verification of Ledger Data Portions

In one embodiment, the artificial intelligence ledger-management system comprises a verification module configured to verify correctness and integrity of ledger data portions stored across a plurality of distributed storage sites. Verification is performed independently of transaction validation and consensus processes and is directed toward ensuring consistency of stored ledger data with an authorized ledger state.

The verification module retrieves ledger data portions from one or more storage sites and performs integrity checks using cryptographic verification mechanisms. Integrity checks may include comparison of cryptographic hashes, verification of Merkle tree roots, validation of authenticated data structures, or confirmation of digital signatures associated with ledger updates. Verification may be performed on entire ledger data portions or on selected subsets thereof.

In one embodiment, verification is performed by comparing cryptographic commitments associated with ledger data portions against reference commitments derived from consensus-authorized ledger updates. Ledger data portions failing verification checks are identified as inconsistent or non-canonical.

Verification may be performed periodically, continuously, or in response to triggering events, including storage site failures, detected anomalies, network disruptions, or receipt of new ledger updates.

### Reconciliation of Ledger Data Portions

In one embodiment, upon detection of inconsistencies among ledger data portions, the artificial intelligence ledger-management system initiates a reconciliation process to restore consistency with a canonical ledger state. Reconciliation is performed under control of a reconciliation module configured to correct, replace, or reconstruct ledger data portions determined to be inconsistent.

In one embodiment, reconciliation is performed by deterministic replay of blockchain transactions. The reconciliation module identifies a known correct ledger state or checkpoint and re-executes protocol-defined transactions subsequent to that state to reconstruct affected ledger data portions. Replayed transactions are executed according to deterministic state-transition rules, ensuring reproducibility of reconstructed ledger state.

In another embodiment, reconciliation is performed by application of state differentials. State differentials represent computed differences between inconsistent ledger data portions and corresponding canonical ledger data. The reconciliation module applies state differentials to update ledger data portions without replaying full transaction histories.

In further embodiments, reconciliation may involve combinations of transaction replay and state differential application, selection of reconciliation techniques being based on factors including ledger size, fault scope, computational cost, or system latency.

### Determination of Canonical Ledger State

In one embodiment, the artificial intelligence ledger-management system determines a canonical blockchain ledger state based on outcomes of verification and reconciliation processes. The canonical ledger state represents the authoritative representation of ledger data that conforms to consensus-authorized updates and protocol rules.

The canonical ledger state may be determined by selecting ledger data portions that satisfy verification criteria, reconstructing ledger data portions through reconciliation, or resolving conflicts based on authorization artifacts such as consensus certificates, cryptographic attestations, or version identifiers.

Possession of ledger data portions alone does not confer canonical authority. Ledger data portions are considered canonical only when verified and reconciled in accordance with the artificial intelligence ledger-management system's verification and reconciliation processes.

### Propagation and Persistence of Canonical State

In one embodiment, once canonical ledger data portions are determined, the artificial intelligence ledger-management system propagates corrected or reconstructed ledger data portions to distributed storage sites according to shard-assignment and replication policies. Storage sites verify received ledger data portions prior to persistence to ensure consistency with the canonical ledger state.

The artificial intelligence ledger-management system updates internal registries or metadata mappings to reflect current storage locations, replication status, and version identifiers associated with canonical ledger data portions.

### Fault Tolerance and Independence From Human Full Nodes

In one embodiment, verification and reconciliation are performed without reliance on independent human-operated full nodes to determine correctness of ledger state. Canonical ledger authority resides within the artificial intelligence ledger-management system, which operates as the final arbiter of ledger state validity.

Verification and reconciliation processes tolerate partial failures, delayed storage updates, or inconsistent replicas, provided that sufficient verified ledger data portions and authorization artifacts are available to reconstruct canonical state.

### Byzantine Fault-Tolerant Consensus Architecture

In one embodiment, the artificial intelligence-operated blockchain system implements a Byzantine fault-tolerant consensus architecture configured to achieve deterministic agreement among a plurality of artificial intelligence ledger-holder agents despite arbitrary, faulty, or malicious behavior by a subset of such agents.

The Byzantine fault-tolerant consensus architecture comprises a communication layer, a proposal handling module, a validation and voting module, a quorum determination module, and a finalization module, each executed by one or more artificial intelligence ledger-holder agents. The consensus architecture is configured such that no single ledger-holder agent is required to be trusted, and correctness of consensus outcomes is preserved so long as the number of faulty or malicious ledger-holder agents remains below a defined fault tolerance threshold.

Each artificial intelligence ledger-holder agent participating in the Byzantine fault-tolerant consensus architecture possesses cryptographic identity credentials enabling authentication and verification of consensus messages. Consensus messages exchanged among the ledger-holder agents are digitally signed and may include transaction identifiers, block proposals, validation results, cryptographic hashes of ledger states, or consensus votes.

The consensus architecture is configured to provide deterministic finality, such that once agreement is reached on a ledger update, the corresponding ledger state is considered final and is not subject to probabilistic reversal.

### Byzantine Fault-Tolerant Consensus Processes

In one embodiment, the Byzantine fault-tolerant consensus process begins with a proposal phase. During the proposal phase, one or more artificial intelligence ledger-holder agents generate or receive a candidate ledger update, which may comprise a proposed transaction or a block containing multiple transactions. Proposal selection may occur according to a leader-based, rotating, or randomized selection mechanism, or may be performed concurrently by multiple agents.

Upon receipt of a proposed ledger update, each artificial intelligence ledger-holder agent independently performs a validation process. Validation includes simulating deterministic state transitions associated with the proposed ledger update, verifying cryptographic signatures, enforcing protocol rules, and confirming consistency with the agent's current ledger state or assigned ledger data portions.

Following validation, each artificial intelligence ledger-holder agent generates a validation result indicating acceptance or rejection of the proposed ledger update. Validation results are encapsulated in signed consensus messages and disseminated to other ledger-holder agents during a voting phase. The voting phase may occur in one or more rounds to account for network latency, message delays, or transient faults.

The quorum determination module evaluates received validation results to determine whether a consensus threshold has been satisfied. The consensus threshold may require agreement from a defined number or proportion of ledger-holder agents, such as a supermajority, and may be weighted based on trust metrics, historical reliability, or staking parameters. The consensus architecture tolerates Byzantine faults by ensuring that agreement cannot be reached solely by faulty or malicious agents.

Upon determination that the consensus threshold has been satisfied, the finalization module generates a consensus authorization artifact, such as an aggregated cryptographic attestation or consensus certificate. The consensus authorization artifact serves as proof that the ledger update has been approved in accordance with the Byzantine fault-tolerant consensus protocol.

The finalized ledger update is then committed to the authoritative ledger state and propagated to storage components or distributed ledger storage sites. Ledger updates finalized through the Byzantine fault-tolerant consensus process are considered authoritative and irreversible except through subsequent protocol-defined governance actions.

### Fault Handling and Liveness Guarantees

In one embodiment, the Byzantine fault-tolerant consensus architecture includes fault detection and recovery mechanisms to maintain liveness in the presence of faulty or unresponsive ledger-holder agents. If consensus is not reached within a defined time interval, the system may initiate additional consensus rounds, select alternate proposal leaders, exclude unresponsive agents from quorum calculations, or adjust consensus parameters.

Consensus messages, validation outcomes, and fault events may be logged by the artificial intelligence system to update trust metrics or anomaly records associated with individual ledger-holder agents. Such records may be used to dynamically adjust participation weight or eligibility in subsequent consensus processes.

### Integration With Artificial Intelligence Ledger-Holder Agents

In one embodiment, the Byzantine fault-tolerant consensus protocol is executed entirely by artificial intelligence ledger-holder agents without reliance on human-operated validator or miner nodes. The artificial intelligence ledger-holder agents act as autonomous consensus participants, performing validation, voting, and finalization functions according to protocol-defined rules.

The Byzantine fault-tolerant consensus process operates independently of user interaction processes. External users may submit transactions or query ledger state but do not participate in consensus voting or quorum determination. User-facing communication, if provided, reflects finalized consensus outcomes and does not influence the consensus process.

### Trust Metrics and Reputation-Weighted Consensus Architecture

In one embodiment, the artificial intelligence-operated blockchain system comprises a trust-evaluation module configured to compute trust metrics associated with individual artificial intelligence ledger-holder agents. The trust-evaluation module may be executed by each artificial intelligence ledger-holder agent, by a subset of such agents, or by a distributed process collectively executed across the ledger-holder agents.

The trust-evaluation module maintains trust records for the artificial intelligence ledger-holder agents. Trust records may comprise one or more quantitative or qualitative indicators reflecting reliability, historical behavior, or system performance of the corresponding ledger-holder agents. Trust records may be stored locally by each ledger-holder agent, shared among agents, or maintained in a distributed registry accessible to the consensus-coordination module.

Trust metrics may include reputation scores, staking parameters, historical validation accuracy, fault incidence rates, uptime metrics, responsiveness measures, anomaly indicators, or other indicators derived from observed behavior of the artificial intelligence ledger-holder agents during validation and consensus processes.

The trust-evaluation module may update trust metrics dynamically based on ongoing system observations. Updates may occur continuously, periodically, or in response to detected events such as validation disagreements, consensus failures, or anomalous behavior.

### Trust-Weighted Validation and Voting Processes

In one embodiment, the consensus-coordination module incorporates trust metrics into the evaluation of validation input received from the artificial intelligence ledger-holder agents. Validation input may comprise acceptance or rejection indicators, cryptographic attestations, or consensus votes generated by the ledger-holder agents.

During consensus determination, the consensus-coordination module applies weighting factors to validation input based on associated trust metrics. Weighting factors may increase or decrease the influence of a given ledger-holder agent's validation input relative to other agents. Weighting may be applied linearly, non-linearly, or according to predefined weighting functions.

In one variation, ledger-holder agents with higher historical validation accuracy or reputation scores contribute greater influence toward consensus thresholds. In another variation, ledger-holder agents associated with staking parameters or economic commitments contribute weighted validation input proportional to such parameters. In further variations, multiple trust metrics may be combined to compute composite weighting values.

The consensus-coordination module evaluates weighted validation input against consensus thresholds to determine whether agreement has been reached. Consensus thresholds may be defined in terms of weighted totals rather than raw counts of validation messages, thereby allowing the system to tolerate a greater number of low-trust or anomalous agents while preserving correctness.

### Trust Metric Formation and Update Processes

In one embodiment, trust metrics are derived from observed validation outcomes over time. The artificial intelligence system may track whether validation input from a ledger-holder agent consistently aligns with finalized consensus outcomes. Ledger-holder agents whose validation input frequently deviates from finalized outcomes may experience reduced trust metrics.

In another embodiment, trust metrics are adjusted in response to fault events, such as repeated communication failures, protocol violations, delayed responses, or detected malicious behavior. Fault events may be logged and incorporated into trust metric calculations.

In one variation, trust metrics are increased for ledger-holder agents demonstrating sustained correct validation behavior, timely participation in consensus rounds, or consistent adherence to protocol constraints. Trust metric adjustments may be bounded to prevent runaway weighting or abrupt changes.

### Integration With Byzantine Fault-Tolerant Consensus

In one embodiment, trust-weighted validation operates within a Byzantine fault-tolerant consensus protocol. The trust-evaluation module is configured such that no single ledger-holder agent, regardless of trust metric, can unilaterally determine consensus outcomes. Consensus thresholds are selected to preserve Byzantine fault tolerance despite weighting.

Trust weighting may be combined with Byzantine fault tolerance by limiting the maximum influence of any individual ledger-holder agent or by requiring weighted agreement across a minimum number of distinct agents. This ensures that consensus correctness is preserved even if high-trust agents become faulty or malicious.

### Optional Governance and Adaptation

In one embodiment, trust metric parameters, weighting functions, or update rules are governed by protocol-defined policies or governance processes. Such policies may be static or subject to modification through authorized governance actions.

Trust metrics may also be used by the artificial intelligence system to inform auxiliary processes, including leader selection for proposal generation, shard assignment decisions, or prioritization of validation responsibilities.

### Relationship to Prior Embodiments

In embodiments described herein, the term ‘ledger holder’ may refer to either human-controlled devices participating in earlier federated-learning embodiments or artificial intelligence ledger-holder agents in later embodiments. In artificial-intelligence-ledger-holder embodiments, authoritative ledger-holding responsibilities are assumed by artificial intelligence agents, and human-controlled devices operate as transaction originators, observers, or limited participants rather than authoritative full nodes.

The artificial-intelligence-ledger-holder embodiments described herein may operate independently of, or in conjunction with, embodiments in which human-controlled devices act as ledger holders. In some variations, the system may transition between human-ledger-holder and artificial-intelligence-ledger-holder modes during deployment, migration, or system evolution.

### System Architecture-Artificial Intelligence Ledger-Holder Agent Architecture

In one embodiment, the blockchain system architecture comprises a plurality of artificial intelligence ledger-holder agents operating as authoritative validation and consensus participants. Each artificial intelligence ledger-holder agent is instantiated as an independent execution environment comprising one or more processors, non-transitory memory, cryptographic key material, and network communication interfaces. The artificial intelligence ledger-holder agents collectively form a validation network responsible for transaction verification, consensus determination, and ledger state finalization.

Each artificial intelligence ledger-holder agent maintains access to ledger state information sufficient to independently validate proposed blockchain transactions. Ledger state information may comprise a complete copy of the blockchain ledger or one or more logically defined ledger data portions corresponding to assigned validation responsibility. Logical assignment of ledger data portions governs validation scope and voting responsibility but does not require exclusive physical storage of ledger data.

The artificial intelligence ledger-holder agents communicate with one another via a peer-to-peer communication layer configured to exchange validation data, cryptographic attestations, and consensus messages. The peer-to-peer communication layer may support broadcast, multicast, or targeted message delivery depending on consensus protocol requirements.

A consensus-coordination module operates across the artificial intelligence ledger-holder agents, either as a distributed protocol executed cooperatively by the agents or as a logically defined coordination layer embedded within each agent. The consensus-coordination module manages proposal dissemination, validation result exchange, agreement evaluation, and ledger update finalization. Consensus determination is performed without reliance on human-operated validator or miner nodes.

External devices interact with the system architecture solely as transaction originators, query clients, or observers. External devices do not participate in consensus, do not generate cryptographic attestations authorizing ledger updates, and do not independently determine canonical ledger state.

### System Architecture-Artificial Intelligence-Controlled Distributed Ledger Storage Architecture

In one embodiment, the blockchain system architecture comprises an artificial intelligence-controlled distributed ledger storage system in which authoritative ledger state is determined by an artificial intelligence ledger-management system operating over a plurality of distributed storage sites. The distributed storage sites may comprise heterogeneous computing systems including data center servers, cloud storage instances, edge devices, or other storage-capable nodes.

The blockchain ledger is segmented into logically defined ledger data portions, where ledger data portions represent groupings of ledger information defined independently of physical storage location. Ledger data portions may correspond to block ranges, transaction ranges, account address ranges, smart-contract identifiers, shard identifiers, or state-variable groupings.

A shard-assignment module executed by the artificial intelligence ledger-management system assigns ledger data portions to one or more distributed storage sites. Shard assignment governs physical or logical placement, replication, and migration of ledger data portions across the distributed storage sites and may be dynamically adjusted in response to load, failures, or system growth.

An integrity-verification module monitors consistency and correctness of ledger data portions stored across the distributed storage sites. Integrity verification may include cryptographic hash verification, Merkle proof validation, or authenticated state comparison. When inconsistencies are detected, a reconciliation module determines corrective action to restore consistency with canonical ledger state.

The reconciliation module may resolve inconsistencies by deterministic replay of blockchain transactions from a known correct state, by application of computed state differentials to affected ledger data portions, or by combinations thereof. The artificial intelligence ledger-management system determines the canonical ledger state based on reconciliation outcomes, independent of human-operated full nodes.

External devices interacting with the architecture may access ledger data through query interfaces or light-client mechanisms but do not independently validate ledger correctness or determine canonical state.

### System Architecture-Integrated Artificial Intelligence Ledger Authority

In one embodiment, the blockchain system architecture integrates artificial intelligence ledger-holder agents and artificial intelligence-controlled distributed ledger storage into a unified artificial intelligence ledger authority. In this architecture, transaction validation, consensus determination, ledger storage, and canonical state reconciliation are collectively managed by artificial intelligence system components operating at different layers of the system.

Artificial intelligence ledger-holder agents perform transaction validation, state-transition simulation, and consensus participation as described previously. Concurrently, an artificial intelligence ledger-management system manages distribution, replication, and reconciliation of ledger data portions across distributed storage sites as described previously.

Validation responsibilities and storage responsibilities are decoupled but coordinated. Artificial intelligence ledger-holder agents may validate transactions affecting specific ledger data portions without being the exclusive physical storage location for those portions. Conversely, distributed storage sites may persist ledger data portions without participating in validation or consensus.

Consensus outcomes produced by the artificial intelligence ledger-holder agents generate cryptographic attestations or consensus certificates authorizing ledger state updates. The artificial intelligence ledger-management system uses such authorizations to update ledger data portions across the distributed storage architecture and to enforce canonical ledger state consistency.

The hybrid architecture enables scalable, fault-tolerant ledger operation by separating concerns among validation, consensus, storage, and reconciliation, while maintaining unified artificial intelligence control over authoritative ledger state. Independent human-operated full nodes are not required to participate in validation, consensus, or canonical state determination.

External devices interact with the hybrid system as transaction originators, observers, or query clients and may receive structured explanatory outputs or ledger information without participating in authoritative ledger operations.

### System Processes-Artificial Intelligence Ledger-Holder Validation and Consensus

In one embodiment, the artificial intelligence ledger-holder agents collectively execute a transaction validation and consensus process. The process begins when a proposed blockchain transaction is received by one or more artificial intelligence ledger-holder agents via a transaction intake interface. Proposed transactions may originate from external client devices, application programming interfaces, smart contracts, or other artificial intelligence ledger-holder agents.

Upon receipt of a proposed transaction, each receiving artificial intelligence ledger-holder agent retrieves a current ledger state or relevant ledger data portions sufficient to evaluate the transaction. The ledger-holder agent simulates one or more deterministic state transitions by executing the transaction in a virtual execution environment that enforces protocol-defined rules without committing changes to the authoritative ledger state.

During simulation, the artificial intelligence ledger-holder agent evaluates transaction validity by checking cryptographic signatures, execution constraints, state consistency, and protocol compliance. The simulation may produce predicted state updates, execution traces, or resource-consumption metrics, which are analyzed to determine whether the transaction satisfies acceptance criteria.

If the transaction is determined to be valid, the artificial intelligence ledger-holder agent generates a cryptographic attestation indicating transaction validity. The cryptographic attestation may include a cryptographic hash of the proposed transaction, a hash of the simulated resulting ledger state, and an agent identifier. If the transaction is determined to be invalid, the agent may generate a rejection indicator or anomaly record.

The artificial intelligence ledger-holder agents exchange validation data and cryptographic attestations through a consensus-coordination process. Validation data may be exchanged in structured rounds, wherein ledger-holder agents disseminate validation results, confirmations, or objections. The consensus-coordination module evaluates received validation data against defined agreement thresholds to determine whether consensus has been reached.

Upon reaching consensus, the artificial intelligence system finalizes a ledger state update corresponding to the validated transaction or a block comprising multiple validated transactions. Ledger finalization occurs without reliance on human-operated validator or miner nodes, and consensus outcomes are recorded for audit and verification purposes.

### System Processes-Artificial Intelligence-Controlled Ledger Distribution and Reconciliation

In one embodiment, the artificial intelligence system executes a ledger distribution and reconciliation process to maintain a canonical blockchain ledger state across a plurality of distributed storage sites. The process begins with logical segmentation of the blockchain ledger into ledger data portions defined independently of physical storage location.

The artificial intelligence system assigns ledger data portions to distributed storage sites using a shard-assignment process. Shard assignment determines which storage sites persist, replicate, or cache particular ledger data portions and may be dynamically adjusted based on system conditions such as load, storage capacity, network latency, or fault detection.

As ledger updates occur, updated ledger data portions or state differentials are propagated to affected storage sites. Each storage site verifies received ledger data portions using cryptographic integrity checks prior to persistence. Storage sites may operate asynchronously and may temporarily diverge from one another due to network delays or failures.

The artificial intelligence system periodically or responsively executes an integrity-verification process to detect inconsistencies among stored ledger data portions. When inconsistencies are detected, a reconciliation process is initiated. Reconciliation may involve deterministic replay of blockchain transactions from a known correct state to reconstruct ledger data portions or application of computed state differentials to correct discrepancies.

Following reconciliation, corrected ledger data portions are redistributed to storage sites as needed to restore consistency with the canonical ledger state. The artificial intelligence system maintains a storage-location registry mapping ledger data portions to storage sites and updates the registry as storage sites are added, removed, or reassigned.

Throughout the process, the artificial intelligence system determines canonical ledger state independently of human-operated full nodes. External devices may query ledger data or receive updates but do not participate in reconciliation or canonical state determination.

### System Processes—Coordinated Artificial Intelligence Validation and Storage Authority

In one embodiment, the artificial intelligence system executes an integrated process combining artificial intelligence ledger-holder validation and artificial intelligence-controlled ledger storage. Transaction validation and ledger storage processes operate concurrently and are coordinated through shared authorization and reconciliation mechanisms.

The process begins when a proposed transaction is received by artificial intelligence ledger-holder agents. The ledger-holder agents simulate deterministic state transitions, evaluate transaction validity, and generate cryptographic attestations as described previously. Validation responsibilities may be distributed among subsets of ledger-holder agents based on ledger data portion assignments.

Consensus outcomes produced by the artificial intelligence ledger-holder agents generate consensus certificates or authorization signals indicating approval of ledger updates. These authorization outputs are communicated to the artificial intelligence ledger-management system responsible for distributed ledger storage.

Upon receipt of authorization, the artificial intelligence ledger-management system updates affected ledger data portions across distributed storage sites. Updated ledger data portions or state differentials are propagated, verified, and persisted in accordance with shard-assignment and replication policies.

If inconsistencies arise between validation outcomes and stored ledger data, the artificial intelligence system executes reconciliation processes to restore consistency. Reconciliation may involve replaying transactions validated by consensus or applying state differentials derived from consensus-authorized ledger updates.

The hybrid process maintains separation of concerns between validation, consensus, storage, and reconciliation while preserving unified artificial intelligence control over authoritative ledger state. Independent human-operated full nodes are not required to validate transactions, store authoritative ledger copies, or determine canonical ledger state.

### Optional System Processes—User Interaction and Disclosure Control

In one embodiment, the artificial intelligence system executes a user interaction process in parallel with ledger operations. External users may submit transactions, query ledger state, or receive structured explanatory outputs describing transaction validation outcomes or consensus results.

User interaction processes are logically isolated from validation, consensus, and reconciliation processes. User-facing outputs are derived from recorded validation data or finalized ledger state and do not permit modification of ledger state, validation logic, or consensus thresholds.

As shown in FIG. 1, the AI blockchain system may feature a plurality of local devices 100, with each local device in the plurality of local devices comprising a processor 102 and a storage medium 104 for storing local data 106; a blockchain 108 and a blockchain node application 110; a neural network 112, with the neural network comprising a global model 114, with the global model comprising global nodes 116, with the global nodes having node weights 118, with the neural network configured to be instructionally and informationally engaged with the blockchain node application; an anomaly database 120; a smart contract assembly 122, with the smart contract assembly comprising one or more smart contracts 124, and configured to be instructionally and informationally engaged with the neural network and the blockchain node application; cryptographic tokens 126 operating via the blockchain, with the cryptographic tokens being managed by the smart contract assembly; with the smart contract assembly comprising or controlling a decentralized data transfer application 128 and an encrypted communication application 130; with the decentralized data transfer application operating on the blockchain, comprising a localized port 132, and providing an exchange interface between the plurality of local devices and the blockchain node application to facilitate the transfer of data.

The decentralized data transfer application may be configured to distribute the operating version of the global model across the plurality of local devices; The localized port may be saved to and configured to operate on the plurality of local devices or configured to be accessed by the plurality of local devices. Each local device may operate as a ledger holder of the blockchain and may be configured to via the localized port train the global nodes by adjusting node weights using the local data. The localized port may be configured to transfer the trained global nodes to the blockchain node application via the decentralized data exchange platform. The blockchain node application may be configured to save the trained global nodes to the blockchain. The smart contract assembly may be configured to transmit cryptographic tokens to the local devices in exchange for transmission of the trained global nodes. The blockchain node application may be configured to update the global model using the trained global nodes to produce the operating global model. The neural network may be trained to periodically or continuously compare the operating global model, database, or assembly with the recent global model, database, or assembly to detect instances of change. The global model may be a version of the global model amongst a set of versions of the global model, with each version of the global model being saved to the blockchain via the blockchain node application. The set of versions of the global model comprising an operating version of the global model and a recent version of the global model, with the recent version of the global model having been deployed prior to the operating version of the global model.

The anomaly database may be a version of the database amongst a set of versions of the database, with each version of the database being saved to the blockchain via the blockchain node application. The set of versions of the database may comprise an operating version of the database and a recent version of the database, with the recent version of the database having been deployed prior to the operating version of the database. The smart contract assembly may be a version of the assembly amongst a set of versions of the assembly, with each version of the assembly being saved to the blockchain via the blockchain node application. The set of versions of the assembly may comprise an operating version of the assembly and a recent version of the assembly, with the recent version of the assembly having been deployed prior to the operating version of the assembly.

As shown in FIG. 2, the smart contract assembly may provide a decentralized data transfer application 200; local devices may receive a global model via the same 202; localized ports of the decentralized data transfer application may assist the local devices in training global nodes using local data 204; the localized port may then transfer the trained global nodes to the blockchain node application 206; the blockchain node application may then save the trained global nodes to the blockchain 208. The smart contract assembly may reward the local devices for training the global nodes with cryptographic tokens 210.

As shown in FIG. 3, the neural network may periodically, continuously, or systematically compare the operating global model, anomaly database, smart contracts assembly, or any other system or application running on the blockchain, with a prior version - or else a changed version with the operating version 300; upon detecting a change, the neural network may search the anomaly database for matching code segments 302; if such matching segments are found and designated as having a risk level or enabling a system vulnerability 304, the neural network may reject such a change 306; if the instances of change do not match segments in the database 308, the neural network may request confirmation of the change from ledger holders 310; identities of local devices approving the changes may be recorded 312, local devices that have not responded to the confirmation request may be barred from cryptographic token distribution 314, and/or local devices that have responded may be rewarded 316.

As shown in FIG. 4, the neural network may be trained to analyze blockchain events transpiring for a given period after attempted instances of change are incorporated into a codebase 400, and then determine whether blockchain event parameters are anomalous by matching the blockchain event parameters to flagged parameters in the anomaly database 402, and testing inputs corresponding to blockchain events in each of the incorporated versions of the codebase as well as the prior versions to determine if there are substantial differences in the parameters 404—and if so, determine if local devices associated with the inputs approved the instances of change 406. If the events are determined to be anomalous 408, the changes are added to the anomaly database 410 and the prior version is reverted to 412.

1. An artificial intelligence-operated blockchain system comprising:
a. one or more artificial intelligence ledger-holder agents executed on one or more computing systems, each artificial intelligence ledger-holder agent comprising at least one processor, non-transitory computer-readable memory, cryptographic key material, and network communication interfaces;
b. wherein each artificial intelligence ledger-holder agent is configured to:
i. maintain a copy of at least a portion of a blockchain ledger corresponding to one or more logically defined ledger data portions;
ii. receive proposed blockchain transactions from external client devices, application programming interfaces, smart contracts, or other artificial intelligence ledger-holder agents;
iii. validate the proposed blockchain transactions by simulating one or more deterministic state transitions of the blockchain ledger using a virtual execution environment without committing changes to an authoritative ledger state; and
iv. generate cryptographic attestations indicating transaction validity based on results of the simulated state transitions;
c. a consensus-coordination module executed by one or more of the artificial intelligence ledger-holder agents and configured to exchange validation data among the artificial intelligence ledger-holder agents and to determine ledger state updates based on agreement among the artificial intelligence ledger-holder agents;
d. wherein blockchain ledger updates are finalized based on consensus reached among the artificial intelligence ledger-holder agents without reliance on human-operated validator or miner nodes.

2. The system of claim 1, wherein the consensus-coordination module implements a Byzantine fault-tolerant consensus protocol.

3. The system of claim 1, wherein the consensus-coordination module weights validation input from the artificial intelligence ledger-holder agents based on reputation scores, staking parameters, historical validation accuracy, or trust metrics.

4. The system of claim 1, wherein each artificial intelligence ledger-holder agent comprises a transaction simulation module configured to generate predicted downstream ledger states, execution traces, or resource-consumption metrics prior to transaction acceptance.

5. The system of claim 1, wherein cryptographic attestations comprise digitally signed data structures including cryptographic hashes of proposed transactions and hashes of simulated resulting ledger states.

6. The system of claim 1, wherein cryptographic attestations generated by multiple artificial intelligence ledger-holder agents are aggregated to form a consensus certificate authorizing ledger update finalization.

7. The system of claim 1, wherein the artificial intelligence ledger-holder agents are configured to assemble validated transactions into candidate blockchain blocks.

8. An artificial intelligence-controlled blockchain system comprising:
a. a distributed ledger storage architecture comprising a plurality of ledger data portions logically defined independently of physical storage location and stored across multiple computing systems;
b. an artificial intelligence ledger-management system comprising:
i. a shard-assignment module configured to assign the ledger data portions to one or more of the multiple computing systems;
ii. an integrity-verification module configured to verify correctness of the ledger data portions using cryptographic verification mechanisms; and
iii. a reconciliation module configured to resolve inconsistencies among ledger data portions across the multiple computing systems;
c. wherein the artificial intelligence ledger-management system determines a canonical blockchain ledger state based on verification and reconciliation of the ledger data portions;
d. and wherein independent human-operated full nodes are not required to determine the canonical blockchain ledger state.

9. The system of claim 8, wherein the shard-assignment module maintains a shard-mapping registry associating ledger data portions with storage locations.

10. The system of claim 8, wherein the integrity-verification module verifies ledger data portions using cryptographic hash commitments, Merkle tree structures, or authenticated data structures.

11. The system of claim 8, wherein the reconciliation module resolves inconsistencies by replaying blockchain transactions or applying state differentials to affected ledger data portions.

12. The system of claim 8, wherein the shard-assignment module dynamically reassigns ledger data portions based on computing load, fault detection, network latency, or storage availability.

13. The system of claim 8, wherein ledger data portions are replicated across multiple computing systems to provide redundancy and fault tolerance.

14. An artificial intelligence-operated blockchain system comprising:
a. a plurality of artificial intelligence ledger-holder agents configured to validate blockchain transactions and participate in consensus determination;
b. a distributed ledger storage architecture comprising ledger data portions distributed across multiple computing systems;
c. an artificial intelligence ledger-coordination system configured to:
i. coordinate consensus among the artificial intelligence ledger-holder agents;
ii. manage distribution, replication, and reassignment of the ledger data portions across the multiple computing systems; and
iii. determine and publish a canonical blockchain ledger state;
d. wherein blockchain ledger updates are finalized based on artificial intelligence-agent consensus and artificial intelligence- controlled ledger coordination without independent human-operated full nodes.

15. The system of claim 14, wherein subsets of the artificial intelligence ledger-holder agents are assigned responsibility for validating transactions affecting specific ledger data portions.

16. The system of claim 14, wherein the artificial intelligence ledger-coordination system exchanges cryptographic summaries, state differentials, or consensus certificates among the artificial intelligence ledger-holder agents.

17. The system of claim 14, wherein the artificial intelligence ledger-coordination system provides a canonical ledger interface for responding to external ledger queries.

18. The system of claim 14, further comprising a disclosure-control module configured to limit visibility of ledger data based on user role or authorization level.

19. The system of claim 18, wherein ledger data disclosed to external users is anonymized, aggregated, or numerically abstracted.

20. The system of claim 14, wherein one or more artificial intelligence ledger-holder agents are configured to provide explanatory outputs to external users describing transaction validation outcomes or consensus results, without permitting external modification of ledger state, validation logic, or consensus thresholds.
